(19) United States
(12) Patent Application Publication
(10) Pub. No.: US 2016/0323203 A1
(43) Pub. Date: Nov. 3, 2016

(54) ACCESS AND DISTRIBUTION ROUTER

(71) Applicant: Compass Electro Optical Systems Ltd., Netanya (IL)

(72) Inventors: Michael MESH, Kefar Sava (IL); Chen GOLDENBERG, Tel-Aviv (IL)

(21) Appl. No.: 14/697,980

(22) Filed: Apr. 28, 2015

(51) Int. Cl. H04L 12/935

(52) U.S. Cl. CPC H04L 49/30

(57) ABSTRACT

Systems and methods for an improved access router. A packet switching system for a packet transfer network includes a plurality of line cards. Each line card includes an electro-optical interconnect in electrical communication with a network processing element associated with the line card. The electro-optical interconnect is configured to send and receive optical signals from each other line card, and directly to end-user equipment, without any intervening electro-optical conversion.

### FIELD OF THE INVENTION

The present invention relates to router and switch architecture in general and, in particular, to an access and distribution router and a packet switching system using a processing device with an electro-optical interface for direct router-user connectivity architecture.

BACKGROUND

Routers and data switching systems share a fundamental architectural structure in the way they are built, perform their operations and handle the data that is going through the system. FIG. 1 describes a generic architecture for such a high speed data switching system. While different systems may vary in implementation, most of the fundamental elements that are described below can be found in all systems, albeit often with its own unique implementation flavor.

FIG. 1 illustrates a router composed of a set of N line cards, including line cards 10 and 10′ which are illustrated. Each of the line cards interfaces to a data network through a set of ingress and egress channels 14 for receiving and sending information to and from the network. As shown in FIG. 1, each of the ingress and egress channels may include a transceiver element 16 configured to accommodate either input to our output from the network.

In a typical packet switching network, the basic information element is a packet and, hence, each line card receives packets from the network and sends packets to the network. Each of the N line cards are connected to each other via an internal interconnect switch fabric 12 that allows sending of information from a set of line cards acting as source line cards, to a set of line cards, acting as destination line cards, in the most efficient way.

As a packet arrives to the line card 10 from the network, it is received by an ingress buffer 20 and then handed to a set of elements 22 that perform various kinds of processing and handling of the packet. In a typical router, this includes elements for processing of the layer headers (e.g., processing of the Ethernet header, in case the interface is Ethernet), and a network processor in the card that performs the destination resolution (based on any of IP address look up, MPLS label look up, and ACL based forwarding using any other field in the packet header, as well any combination of fields), which leads to a decision to which line card the packet should be sent (line card 10′ in this example). In addition, any ingress features that were configured are applied at this stage. Some examples of such features are filtering, policing, statistics updates, header fields updates, such as TOS/EXP, TTL, etc., or searches in other fields of the packet, all as per the specific configuration. After all the required operations are completed, the packet, whose destination egress path is now known, is held in a switch fabric buffer 24 until its turn comes to be sent over the switch fabric interconnect 12 to the destination line card.

The packet is subsequently received at a switch fabric buffer 26 from the switch fabric interconnect 12 and is further processed in accordance with standard egress processing by egress processing elements 28. The processed packet is then held by the egress buffer 29 until it can be sent over the network.

There are many different types of switch fabric architecture, each implementing an interconnect between N line cards, where each line card may need to send information to any of the other N−1 line cards. Signals may be sent in unicast or multicast, and a switch fabric algorithm optimizes the usage of the interconnect to manage the various exchanges between the line cards. Each packet traverses the switch fabric and arrives at a destination line card through which it will egress the system.

As illustrated, the common router architecture includes, as an example of the transceiver element 16, an optical interface to connect line cards to the end user's equipment or to the other routers (which also can be user's equipment) or to the equipment on different layers of the networks. This optical interface is mainly transceivers (transmitters and receivers in one package) in different form (for example SFP or SFP plus or CFP2 or CFP4) which can provide data transmission over different distances.

One issue facing switching and routing architectures, particularly as solutions for medium to large enterprise networks, is the fidelity of the signal across electrical connections between elements. High bandwidth data transmission over even relatively short distances across a line card or between line cards requires some kind of amplification and specific efforts to keep signal integrity. Consequently the cost of line cards is growing as well as power consumption.

Another problem is related to the current network architecture. The routers are mainly connected to equipment with the same optical interfaces, which means two transceivers are used to deliver data from point to point—a first transceiver at packet ingress to convert an optical input to an electrical signal for processing over the router, and then a second transceiver at packet egress to convert back to an optical output. This redundant cost and complexity is particularly notable at the access and distribution layers of an enterprise network, where minimizing the cost-per-port is of particular concern to many businesses.

Accordingly, there is a long felt need for a simplified access router performing needed connectivity configuration directly at the output line card only.

### SUMMARY

Systems and methods for routing network data are disclosed. Various embodiments of a switching and routing architecture including line cards are described. The line cards include processors with integral electro-optical IO interconnects such that each line card can receive optical signals directly from end devices or networks without the presence of an external opto-electrical transceiver. Optical signals are transmitted directly between line cards without the need for any intervening electro-optical conversion. This reduces the necessary size and complexity of the architecture while increasing its overall speed and data capacity.

According to an embodiment of the present disclosure, a packet switching system for a packet transfer network includes a plurality of line cards. Each line card includes an electro-optical interconnect in electrical communication with a network processing element associated with the line card. The electro-optical interconnect is configured to send and receive optical signals from each other line card without any intervening electro-optical conversion.

In accordance with other aspects of this embodiment, the electro-optical interconnect of each line card can be configured to directly receive optical signals representing a packet from one or more devices outside the packet system without any intervening electro-optical conversion.

In accordance with other aspects of this embodiment, each line card can be associated with a front panel and a back panel. The front panel can include a plurality of optical pathways in communication with at least one of a network and an end user. The back panel can include a plurality of optical pathways in communication with the other line cards.

In accordance with other aspects of this embodiment, each line card can be associated with a front panel. The front panel and include a plurality of a plurality of optical pathways in communication with at least one of a network and an end user and a plurality of optical pathways in communication with the other line cards.

In accordance with other aspects of this embodiment, the electro-optical interconnect of each line card can include a CMOS chip with at least one sending opto-electronic element and at least one receiving opto-electronic element.

In accordance with further aspects of this embodiment, the at least one sending opto-electronic element can include a plurality of vertical-cavity surface-emitting lasers (VCSELs) arranged in an array. For each of the line cards, each of the other line cards can be associated with a particular one of the plurality of VCSELs arranged in the array such that optical signals representing a packet are sent from the line card to one of the other line cards by activation of the particular VC SEL.

In accordance with further aspects of this embodiment, the at least one receiving opto-electronic element can include a plurality of photo-detectors (PDs) arranged in an array. For each of the line cards, each of the other line cards can be associated with a particular one of the plurality of PDs arranged in the array such that optical signals representing a packet are sent from one of the other line cards and received by the particular PD.

In accordance with other aspects of this embodiment, for a first line card, optical communication between the line card and an end user device can be mediated by means of a distribution connector receiving a fiber bundle from the first line card.

In accordance with further aspects of this embodiment, the distribution connector can receive a plurality of fiber bundles from a plurality of different line cards within the packet switching system.

While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 illustrates a configuration for a typical switching and routing architecture.

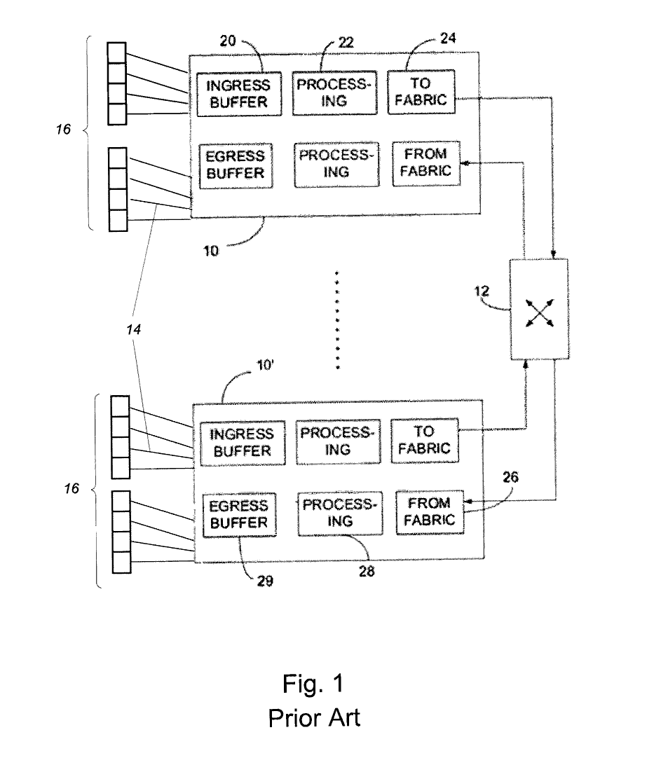

FIG. 2 illustrates a line card in accordance with embodiments of the present invention.

FIG. 3 illustrates a line card with a back plate in accordance with embodiments of the present invention.

FIG. 4 illustrates a line card with no back plate in accordance with embodiments of the present invention.

FIG. 5 illustrates a line card with multiple interconnect chips in accordance with embodiments of the present invention.

FIG. 6 illustrates an electro-optical interconnect with VCSEL and PD elements in accordance with embodiments of the present invention.

FIG. 7 illustrates a line card with a distribution connector in accordance with embodiments of the present invention.

FIG. 8 illustrates a distribution connector in accordance with embodiments of the present invention.

FIG. 9 illustrates optical connection components in accordance with embodiments of the present invention.

### DETAILED DESCRIPTION

The present invention relates to a switch and router architecture for a packet switching system in which each line card of the N line cards uses an electro-optical interface assembled on a switch chip. That is, each line card is configured with a chip that directly reads and converts a received optical signal, either from one of the other N−1 line cards in the backplane or from network ingress and egress channels, without the need for an intermediate transceiver.

This is accomplished by coupling the input of each line card to the output of every other line card in the network via an electro-optical input-output (IO) interconnect and vice versa coming through the fibers to the backplane, and coupling of the input of each line card to the output of every interface of end user equipment and vice versa coming through optical fibers to the front panel of each line card. Packets come from end user devices directly to the electro-optical interface on the switch chip as optical signals and, after processing, go forward to the other line cards of the router or to the line cards in the network or back to the end user interface as optical signals again.

This structure and connectivity method provides efficient direct networking for access and distribution parts of network, leading to a simpler networking, more accurate quality of service behavior due to the dedicated bandwidth allocation for each user, and a smaller system.

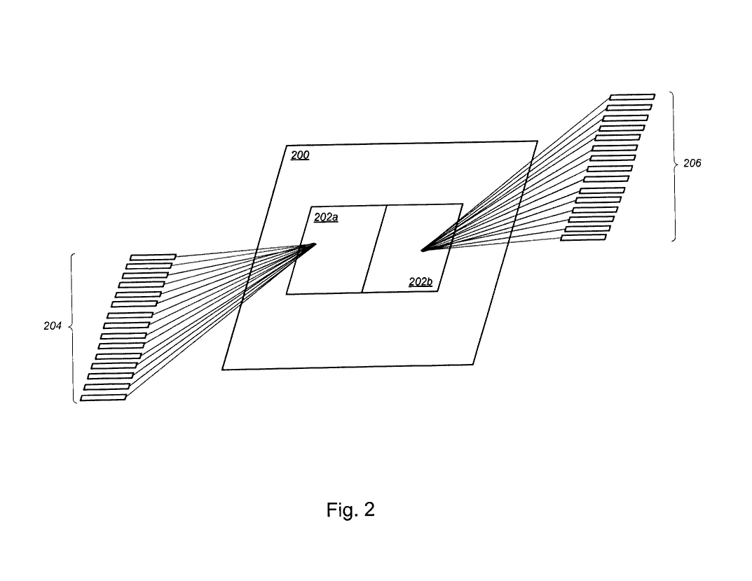

FIG. 2 illustrates a high-level schematic for the line card architecture. A line card 200 includes electro-optical IO chips 202a, 202b each accommodating a plurality of input and output channels. The front chip 202a sends and receives optical signals through the front channels 204, which may be associated with a front panel and connections external to the router such as end user and network connections. The back chip 202b sends and receives optical signals through the back channels 206, which may be associated with the backplane and connections to other line cards as part of the switch and router architecture.

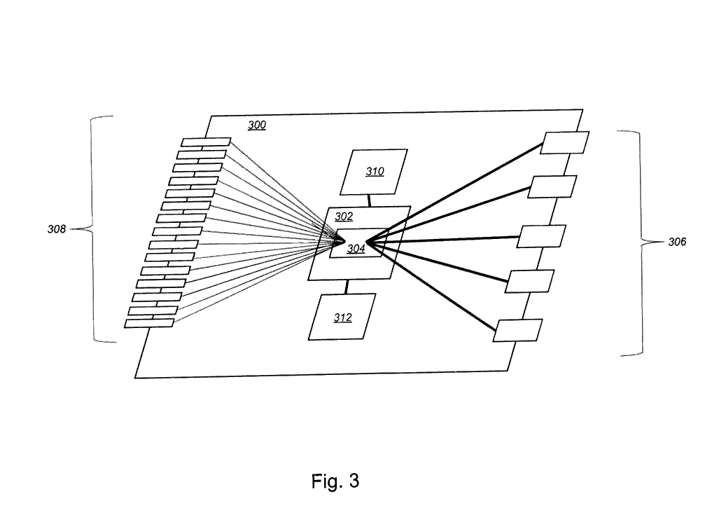

An implementation of the present invention is shown in FIG. 3, wherein the elements shown in FIG. 3, namely a single line card 300 with its associated hardware and connectors, may be assembled integrally within a single chassis as a unit or “box.” There is thus provided, according to one embodiment of the invention, a packet switching system for a packet transfer network, the system having an architecture including a plurality of line cards 300, each including a processor 302 assembled with an electro-optical IO interconnect 304 coupling the line cards 300 to one another through the backplane 306. The processor 302 is coupled by means of the electro-optical IO interconnect 304 to network and end-user devices via fiber-optic elements through the front panel 308. Other processing elements, such as a network processor 310 and memory 312, may also be included on the chip associated with the line card 300.

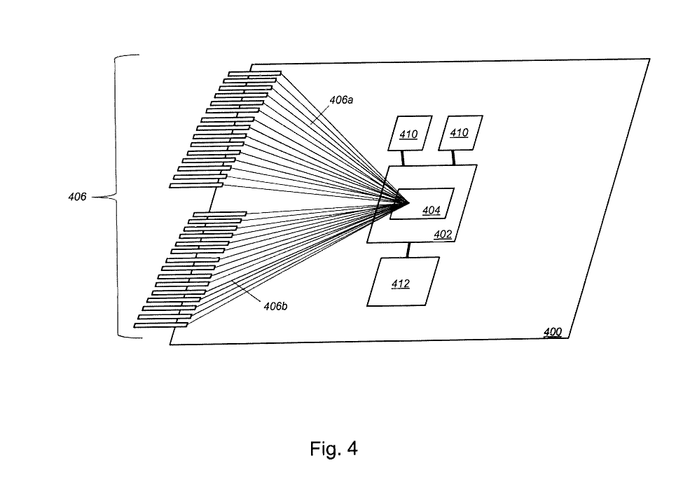

FIG. 4 illustrates another embodiment of how the elements in a single “box” for a particular line card 400 as part of a switching network might be configured. This embodiment eliminates the backplane. The electro-optical IO interconnect 404 couples the processing elements, illustrated in FIG. 4 as chip 402, on the line card in one box to one another line card in another box through the front panel 406, the connection represented by the first set of optical elements 406a, and also couples (by means of the same electro-optical IO interconnect 404) the chip 402 to end user devices through the fibers 406b in the front panel 406. Processed data is sent via the electro-optical IO interconnect 404 on the same chip 402 through the front panel 406 to the end user equipment or to the network. Network processor 410 and memory 412 elements are also shown.

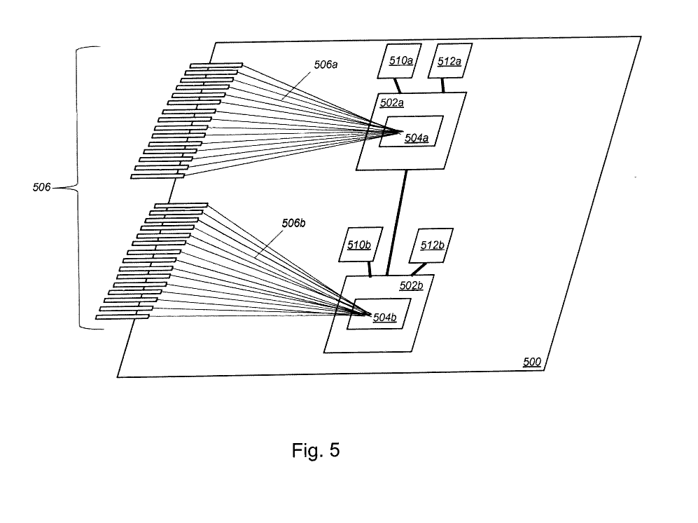

According to another embodiment, as illustrated in FIG. 5, the electro-optical IO interconnect for a line card 500 may include a plurality of integrated circuit chips 502a and 502b in electrical communication therewith, each with a separate electro-optical IO interconnect 504a,b; network processing elements 510a,b; and memory elements 512a,b. Ingress and egress processing for a particular packet may potentially be handled by different chips, such as if the chip 502a handles communication to and from a network or end user (via optical elements 506a) while the chip 502b handles communication to and from other line cards within the switch architecture (via optical elements 506b). The two or more integrated chips may still handle all traffic through a front panel 506 as shown.

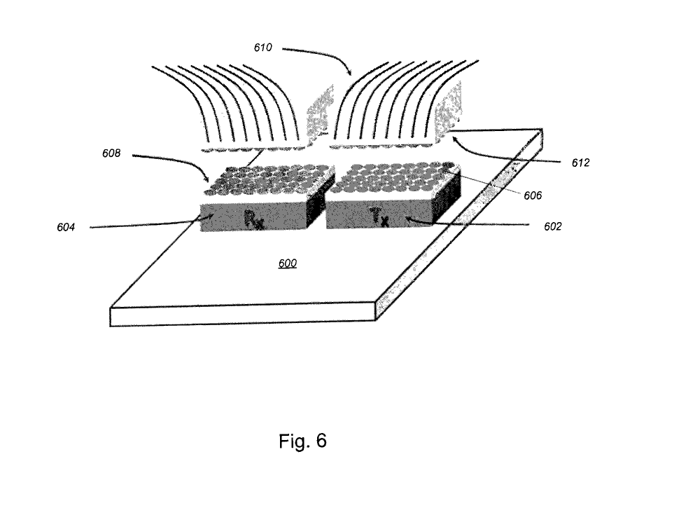

The electro-optical IO interconnect used in various implementations of the present invention may be of any configuration appropriate to allow the switch chip to process input optical signals and subsequently output optical signals without the use of an external transceiver. One implementation, illustrated in FIG. 6, includes a CMOS chip 600 with opto-electronic elements for both sending (602) and receiving (604) optical signals. The sending element 602 includes an array of vertical-cavity surface-emitting lasers (VCSELs) 606 as well as the necessary interface circuitry to send packets as optical signals using the VCSELs 606. The receiving element 604 includes an array of photo-detection elements (PDs) 608, as well as the necessary interface circuitry to receive and process optical signals using the PDs 608. The CMOS 600 also includes the necessary integrated network processing elements and memory circuitry to carry out ingress and/or egress processing as described above. As shown, the VCSELS 606 and PDs 608 are each coupled to a bundle of fibers 610 through an array of lenses 612. Further implementations of suitable opto-electronic IO interconnects can be found in Applicant's U.S. Pat. No. 7,702,191, granted on Apr. 20, 2010, and U.S. patent application Ser. No. 13/543,347, filed Jul. 6, 2012, each of which is herein incorporated by reference as though included in its entirety.

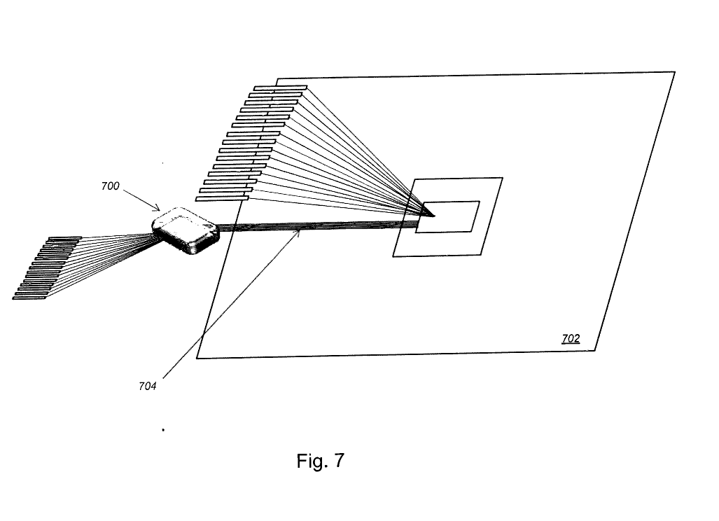

FIG. 7 shows the deployment of a distributed connector 700 in conjunction with a line card 702 in accordance with embodiments of the present invention. The distribution connector 700 may receive a fiber bundle 704 from the line card 702 and provide any connectivity necessary for a client interface. This can allow for ease of connection and system scaling. Fiber bundles may be assembled according to, for example, the fiber bundle described in Applicant's U.S. Pat. No. D675996, granted Feb. 12, 2013, which is herein incorporated by reference as though included in its entirety.

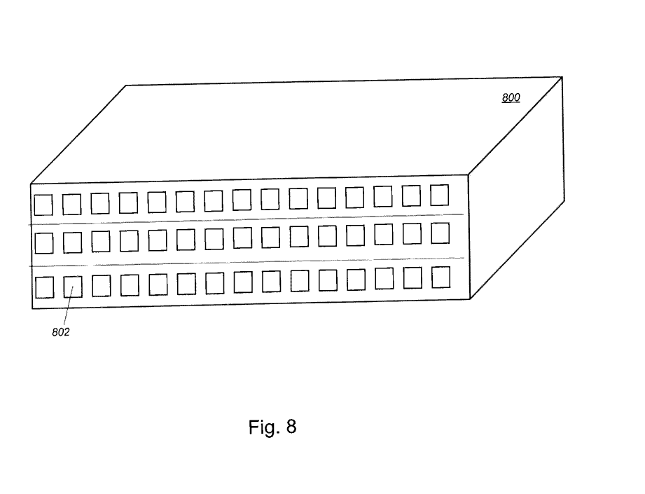

An example of a distribution connector 800 is shown in FIG. 8. The distribution connector 800 can receive one or more fiber bundles from the front panels of one or more line cards as necessary, and distribute the resulting fiber signals to end user devices through the various connection elements 802. Distribution connectors 800 allow for easy scaling up of the architecture described herein to larger networks. In some implementations, each CMOS chip associated with a particular electro-optical 10 interconnect may include the capacity for as many as 168 individual transmission channels, each connected by its own optical fiber. By means of distribution connectors 800 and other optical components, any number of such chips and fibers may be used to accommodate the requirements of any particular network.

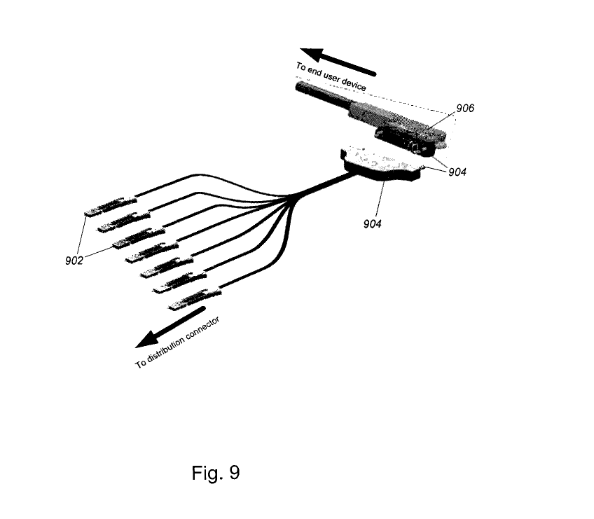

An example of components for connectivity between the router and end user devices is shown in FIG. 9, in which multiple optical fibers from a distribution connector can be combined on the end-user side into a single bundle. The optical elements 902 interface with individual connection elements of the distribution connector, but as shown are aggregated into a single optical connection component 904. Alignment elements 906 allow the user to properly connect the optical connection component 904 to the fiber bundle 906, which in turn is attached to one or more end user devices.

The information transmission of a particular VCSEL and PD elements of the kind described with respect to the electro-optical IO interconnect may, in some implementations, have a known customary bit rate of anywhere between 10 and 25 Gbps. By aggregating multiple fibers into a bundle as illustrated, the bandwidth requirements of any particular user network and/or device may be met by bundling the appropriate number of fibers to meet those requirements. These bandwidth parameters can be adjusted as necessary to accommodate changing needs and configurations of the system.

Devices according to embodiments of the present invention can be smaller and more efficient than those of the prior art as they eliminate redundant transceivers and send optical rather than electrical signals across the switching and routing architecture. Even at very low power, implementations as described have been demonstrated accommodate high-bandwidth data transfer above 25 Gbps and can simultaneously process both upstream and downstream traffic.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. For example, potentially any electro-optical IO interconnect could benefit from the techniques disclosed herein. Thus, such other embodiments and modifications are intended to fall within the scope of the present disclosure. Further, although the present disclosure has been presented herein in the context of at least one particular implementation in at least one particular environment for at least one particular purpose, those of ordinary skill in the art will recognize that its usefulness is not limited thereto and that the present disclosure can be beneficially implemented in any number of environments for any number of purposes. Accordingly, the claims set forth below should be construed in view of the full breadth and spirit of the present disclosure as described herein.

What is claimed is:

1. A packet switching system for a packet transfer network comprising:
a plurality of line cards,
each line card including an electro-optical interconnect in electrical communication with a network processing element associated with the line card, the electro-optical interconnect configured to send and receive optical signals from each other line card without any intervening electro-optical conversion.

2. The system of claim 1, wherein the electro-optical interconnect of each line card is configured to directly receive optical signals representing a packet from one or more devices outside the packet system without any intervening electro-optical conversion.

3. The system of claim 1, wherein each line card is associated with:
a front panel comprising a plurality of optical pathways in communication with at least one of a network and an end user; and
a back panel comprising a plurality of optical pathways in communication with the other line cards.

4. The system of claim 1, wherein each line card is associated with a front panel comprising:
a plurality of optical pathways in communication with at least one of a network and an end user; and
a plurality of optical pathways in communication with the other line cards.

5. The system of claim 1, wherein the electro-optical interconnect of each line card comprises a CMOS chip with at least one sending opto-electronic element and at least one receiving opto-electronic element.

6. The system of claim 5, wherein the at least one sending opto-electronic element comprises a plurality of vertical-cavity surface-emitting lasers (VCSELs) arranged in an array.

7. The system of claim 6, wherein, for each of the line cards, each of the other line cards is associated with a particular one of the plurality of VCSELs arranged in the array such that optical signals representing a packet are sent from the line card to one of the other line cards by activation of the particular VCSEL.

8. The system of claim 6, wherein the at least one receiving opto-electronic element comprises a plurality of photo-detectors (PDs) arranged in an array.

9. The system of claim 8, wherein, for each of the line cards, each of the other line cards is associated with a particular one of the plurality of PDs arranged in the array such that optical signals representing a packet are sent from one of the other line cards and received by the particular PD.

10. The system of claim 1, wherein for a first line card, optical communication between the line card and an end user device is mediated by means of a distribution connector receiving a fiber bundle from the first line card.

11. The system of claim 10, wherein the distribution connector receives a plurality of line bundles from a plurality of different line cards within the packet switching system.
